(19) United States
(12) Patent Application Publication
(10) Pub. No.: US 2008/0059365 A1
(43) Pub. Date: Mar. 6, 2008

(54) SYSTEM AND METHOD FOR UPDATING CLAUSES IN CONTRACTS

(75) Inventors: CHUNG-I LEE, Tu-Cheng (TW); HAI-HONG LIN, Shenzhen (CN); GANG PENG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/560,853

(22) Filed: Nov. 17, 2006

(30) Foreign Application Priority Data
Aug. 10, 2006 (CN) 200610200789.0

(51) Int. Cl. G06Q 40/00

(52) U.S. Cl. 705/38

(57) ABSTRACT

A computer-based method for updating clauses in contracts is disclosed. The method includes the steps of: receiving new risk clauses, the new risk clauses being created based upon potential market risks; receiving a selection of risk clauses, searching for contract clauses in a contract clause database based on the categories of the selection of risk clauses thereby yielding identified contract clauses, and selecting disadvantageous contract clauses from the identified contract clauses; finding disadvantageous contracts containing one or more of the disadvantageous contract clauses in an existing contract database; generating a report listing the disadvantageous contracts; transmitting each of the disadvantageous contracts in the report to a corresponding offer accepter; determining by the corresponding offer accepter whether there is a need to modify the disadvantageous contract; creating new contracts by updating the disadvantageous contract clauses of the existing contract with the selection of risk clauses correspondingly if there is a need to modify the disadvantageous contract. A related system is also disclosed.

### BACKGROUND OF THE INVENTION

1. Field of the Invention

The present invention is related to systems and methods for updating contents of a text document, especially a system and method for updating clauses in contracts.

2. Description of related art

In a complex market, clauses (terms & conditions) in contracts may bear certain risks, pending market conditions, the risks may realize and the clauses may become disadvantageous. Traditionally, updating contracts clauses are done manually, involving reading through old contracts and issuing new ones, this takes up a lot of resources and is prone to errors, as a result disadvantageous clauses may be left misread, un-noticed, and un-updated on the updated contract.

Therefore, what is needed is a system and method for updating clauses in contracts, by which the offer accepter can find out the disadvantageous contracts easily and accurately.

### SUMMARY OF THE INVENTION

A system for updating clauses in contracts is provided in accordance with a preferred embodiment. The system includes a central computer and a storage connected with the central computer. The storage has an existing contract database, a contract clause database, and a risk clause database. The central computer includes: a risk clause setting module for receiving new risk clauses created based upon potential market risks, and storing the risk clauses in the risk clause database; a disadvantageous contract searching module for receiving a selection of risk clauses, searching for contract clauses in the contract clause database based on the categories of the selection of risk clauses thereby yielding identified contract clauses, selecting disadvantageous contract clauses from the identified contract clauses, and finding disadvantageous contracts containing one or more of the disadvantageous contract clauses in the existing contract database; a report generating module for generating a report listing the disadvantageous contracts; a risk notifying module for transmitting each of the disadvantageous contracts in the report to a corresponding offer accepter; and a contract updating module for creating new contracts by updating the disadvantageous contract clauses of the existing contract with the selection of risk clauses correspondingly.

A computer-based method for updating clauses in contracts is also provided. The method includes the steps of: receiving new risk clauses, the new risk clauses being created based upon potential market risks; receiving a selection of risk clauses, searching for contract clauses in a contract clause database based on the categories of the selection of risk clauses thereby yielding identified contract clauses, and selecting disadvantageous contract clauses from the identified contract clauses; finding disadvantageous contracts containing one or more of the disadvantageous contract clauses in an existing contract database; generating a report listing the disadvantageous contracts; transmitting each of the disadvantageous contracts in the report to a corresponding offer accepter; determining by the corresponding offer accepter whether there is a need to modify the disadvantageous contract; creating new contracts by updating the disadvantageous contract clauses of the existing contract with the selection of risk clauses correspondingly if there is a need to modify the disadvantageous contract.

Other systems, methods, features, and advantages of the present invention will be or become apparent to one with skill in the art upon examination of the following drawings and detailed description.

### BRIEF DESCRIPTION OF THE DRAWINGS

FIG. 1 is a schematic diagram of hardware configuration of a system for updating clauses in contracts in accordance with a preferred embodiment;

FIG. 2 is a schematic diagram showing function modules of a central computer of the system of FIG. 1; and

FIG. 3 is a flowchart of a preferred method for updating clauses in contracts, in accordance with one embodiment of the present invention.

### DETAILED DESCRIPTION OF THE INVENTION

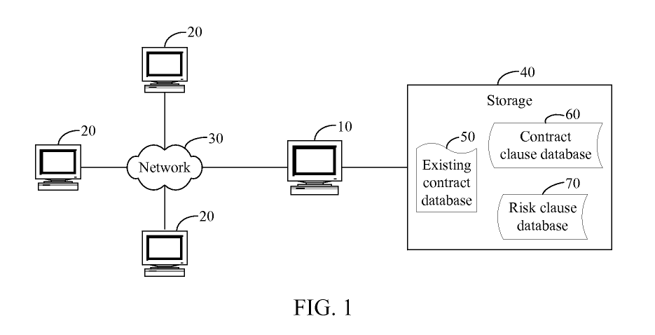

FIG. 1 is a schematic diagram of hardware configuration of a system for updating clauses in contracts (hereinafter, “the system”) in accordance with a preferred embodiment. The system includes a central computer 10, one or more computer terminals 20 connected with the central computer 10 through a network 30, and a storage 40. Each of the computer terminals 20 is associated with one or more specific offer accepters, and the offer accepter is the owner of a specific contract, such as a supervisor or a manager. The network 30 is a data network for exchanging data between the central computer 10 and the computer terminals 20. For example, the network 30 may be an internet protocol (IP) network that enables a communication between the central computer 10 and the computer terminals 20 through a transport control protocol-internet protocol (TCP-IP) stack.

The storage 40 typically contains an existing contract database 50, a contract clause database 60, and a risk clause database 70. The existing contract database 50 includes contracts of different offer accepters. All contracts include a plurality of contract clauses and information of the offer accepters of the contracts correspondingly.

The contract clause database 60 stores all contract clauses of the existing contracts; the contract clauses are categorized by different clause types, such as subject-matter, guarantee period, price, or fulfill mode. Preferably, each of the contract clauses has a unique clause ID.

The risk clause database 70 includes risk clauses created based upon potential market risks. The risk clauses are also categorized by different clause types, such as subject-matter, guarantee period, price, and fulfill mode. When market conditions change, contract administrators may input new risk clauses into the risk clause database 70 according to potential market risks.

The central computer 10 is configured for searching for disadvantageous contracts that have disadvantageous contract clauses from the existing contract database 50, generating a report listing the disadvantageous contracts, transmitting each of the disadvantageous contracts listed in the report to a corresponding offer accepter through the network 30, and creating new contracts according to the feedback information of the corresponding offer accepter.

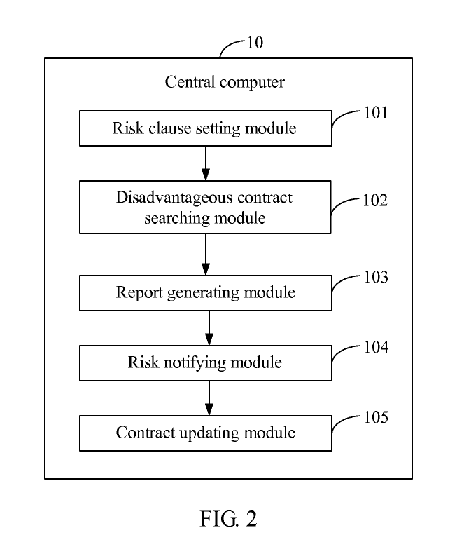

FIG. 2 is a schematic diagram showing function modules of the central computer 10. From a functional point of view, the central computer 10 includes a risk clause setting module 101, a disadvantageous contract searching module 102, a report generating module 103, a risk notifying module 104, and a contract updating module 105.

The risk clause setting module 101 is used for receiving new risk clauses created based upon potential market risks, and storing the risk clauses in the risk clause database 70. The disadvantageous contract searching module 102 is used for receiving a selection of risk clauses, searching for contract clauses in the contract clause database 60 based on the categories of the selection of risk clauses thereby yielding identified contract clauses. Then the 102 analyzes and detects if the identified contract clauses are disadvantageous contract clauses, and selects the disadvantageous contract clauses from the identified contract clauses. Finally, the 102 finds disadvantageous contracts containing one or more of the disadvantageous contract clauses in the existing contract database 50 by using the clause IDs of the disadvantageous contract clauses.

The report generating module 103 is used for generating a report listing the disadvantageous contracts located by the disadvantageous contract searching module 102. The report typically includes all the disadvantageous contracts and the disadvantageous contract clauses in each disadvantageous contract.

The risk notifying module 104 is used for transmitting each of the disadvantageous contracts in the report to the corresponding offer accepter through the network 30.

The contract updating module 105 is used for creating new contracts by updating the disadvantageous contract clauses of the existing contract with the selection of risk clauses correspondingly, and saving the new contracts as existing contracts and the risk clauses as contract clauses into the existing contract database 50 and the contract clause database 60 respectively.

The implementation of the system can be better illustrated by an example as follows. If market conditions change, for example, that a guarantee period changes from 60 days to 50 days, there is need to decide whether the change would bring contractual risks for an enterprise.

At first, the risk clause setting module 101 receives a new guarantee period clause (i.e. 50 days), and stores the new guarantee period clause in the risk clause database 70. Then, the disadvantageous contract searching module 102 receives a selection of the new guarantee period clause, searches the contract clauses for disadvantageous contract clauses based on the type of the new guarantee period clause, and compares each of the guarantee period of the guarantee period clauses with the guarantee period of the selection of guarantee period clause.

If the guarantee period of any of the guarantee period clause is greater than 50, the disadvantageous contract searching module 102 determines that the guarantee period clause as a disadvantageous contract clause. The disadvantageous contract searching module 102 selects all such disadvantageous contract clauses, and locates disadvantageous contracts in the existing contract database 50 by using the clause ID of the disadvantageous contract clauses. Each of the disadvantageous contracts has one or more of the disadvantageous contract clauses.

Then, the report generating module 103 generates a report of the disadvantageous contracts obtained by the disadvantageous contract searching module 102, and the risk notifying module 104 transmits each of the disadvantageous contracts in the report to the corresponding offer accepter to determine whether there is a need to modify the disadvantageous contract.

If there is a need to modify the disadvantageous contract, the offer accepter sends feedback information to the central computer 10. The contract updating module 105 replaces the disadvantageous contract clauses with the new guarantee period clause, and creates a new contract having the new guarantee period clause.

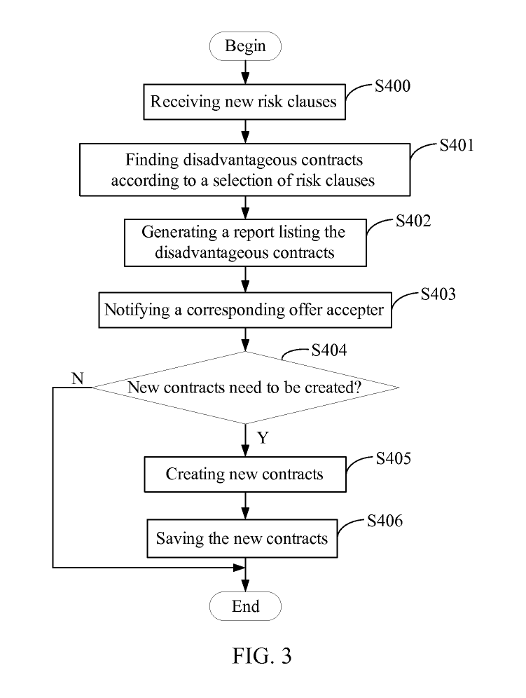

FIG. 3 is a flowchart of a preferred method for updating clauses in contracts. In step S400, the risk clause setting module 101 receives new risk clauses created based on market conditions, and stores the risk clauses in the risk clause database 70.

In step S401, the disadvantageous contract searching module 102 receives a selection of risk clauses, searches for contract clauses in the contract clause database 60 based on the categories of the selection of risk clauses thereby yielding identified contract clauses. Then 102 analyzes and detects if the identified contract clauses are disadvantageous contract clauses, and selects the disadvantageous contract clauses from the identified contract clauses. Finally, the 102 finds disadvantageous contracts containing one or more of the disadvantageous contract clauses in the existing contract database 50 by using the clause IDs of the disadvantageous contract clauses.

In step S402, the report generating module 103 generates a report listing the disadvantageous contracts located by the disadvantageous contract searching module 102. The report typically includes all the disadvantageous contracts and the disadvantageous contract clauses in each disadvantageous contract.

In step S403, the risk notifying module 104 transmits each of the disadvantageous contracts in the report to the corresponding offer accepter through the network 30. In step S404, the offer accepter determines whether there is a need to modify the disadvantageous contract, and sends feedback information to the central computer 10.

If there is a need to modify the disadvantageous contract, in step S405, the contract updating module 105 creates new contracts by updating the disadvantageous contract clauses of the existing contract with the selection of risk clauses correspondingly.

In step S406, the contract updating module 105 saves the new contracts as existing contracts and the risk clauses as contract clauses into the existing contract database 50 and the contract clause database 60 respectively.

If there is not a need to modify the disadvantageous contract, the procedure ends.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for updating clauses in contracts, the system comprising a central computer and a storage connected with the central computer, the storage having an existing contract database, a contract clause database, and a risk clause database, the central computer comprising:
a risk clause setting module for receiving new risk clauses created based upon potential market risks, and storing the risk clauses in the risk clause database;
a disadvantageous contract searching module for receiving a selection of risk clauses, searching for contract clauses in the contract clause database based on the categories of the selection of risk clauses thereby yielding identified contract clauses, selecting disadvantageous contract clauses from the identified contract clauses, and finding disadvantageous contracts containing one or more of the disadvantageous contract clauses in the existing contract database;
a report generating module for generating a report listing the disadvantageous contracts; and
a risk notifying module for transmitting each of the disadvantageous contracts in the report to a corresponding offer accepter.

2. The system according to claim 1, wherein the report of the disadvantageous contracts includes all the disadvantageous contracts and the disadvantageous contract clauses in each disadvantageous contract.

3. A computer-based method for updating clauses in contracts, the method comprising the steps of:
receiving new risk clauses, the new risk clauses being created based upon potential market risks;
receiving a selection of risk clauses, searching for contract clauses in a contract clause database based on the categories of the selection of risk clauses thereby yielding identified contract clauses, and selecting disadvantageous contract clauses from the identified contract clauses;
finding disadvantageous contracts containing one or more of the disadvantageous contract clauses in an existing contract database;
generating a report listing the disadvantageous contracts; and
transmitting each of the disadvantageous contracts in the report to a corresponding offer accepter.

4. The method according to claim 3, wherein the report of the disadvantageous contracts includes all the disadvantageous contracts and the disadvantageous contract clauses in each disadvantageous contract.
